(19) United States
(12) Patent Application Publication
(10) Pub. No.: US 2011/0141146 A1
(43) Pub. Date: Jun. 16, 2011

(54) ELECTRONIC APPARATUS AND METHOD OF CONTROLLING THE SAME

(75) Inventors: Yong-beom Bahg, Gyeonggi-do (KR); Mi-ra Eom, Gyeonggi-do (KR); Ji-won Im, Gyeonggi-do (KR); Ki-young Kim, Incheon (KR)

(73) Assignee: SAMSUNG ELECTRONICS CO., LTD., Gyeonggi-Do (KR)

(21) Appl. No.: 12/814,549

(22) Filed: Jun. 14, 2010

(30) Foreign Application Priority Data
Dec. 11, 2009 (KR) 10-2009-0123410

(51) Int. Cl. G09G 5/00

(52) U.S. Cl. 345/661

(57) ABSTRACT

An electronic apparatus and method of controlling or performing a plurality of executable functions. The electronic apparatus includes: a display that displays an image corresponding to at least one executable function; an input unit that receives input from a user; and a controller that changes a size of the image according to the input from the user and performs at least one of automatic execution of the function and automatic closure of the function being performed in accordance with an extent of a change in the size of the image.

### CLAIM OF PRIORITY

This application claims priority from Korean Patent Application No. 10-2009-0123410, filed on Dec. 11, 2009 in the Korean Intellectual Property Office, the disclosure of which is incorporated herein by reference in its entirety.

### BACKGROUND OF THE INVENTION

1. Field of the Invention

The present invention relates to an electronic apparatus and a method of controlling the same. More particularly, the present invention relates to an electronic apparatus for performing a plurality of executable functions and a method of controlling the same.

2. Description of the Related Art

When performing in an electronic apparatus a function of, for example, music, a photo, a video, a document, or the like, a user generally runs a program to execute the function first and then activates the function via the running program. Thus, in order to execute a function of music, a photo, a video, a document, etc., a user needs to perform a plurality of operations to execute a desired function. There is thus a need in the art to simplify this process.

### SUMMARY OF THE INVENTION

Accordingly, the present invention provides a user interface and an interfacing method which is convenient and immediate in controlling or performing a plurality of executable functions in an electronic apparatus.

According to an exemplary aspect of the present invention, there is provided an electronic apparatus preferably including: a display displaying an image corresponding to at least one executable function; an input unit receiving input from a user; and a controller changing a size of the image according to the input from the user and carrying out at least one of automatic execution of the function and automatic closure of the function being performed in accordance with an extent of a change in the size of the image.

The controller, for example, may perform at least one of enlarging and reducing the image according to the particular input received from the user.

The image may include, for example, at least one of an icon displaying a corresponding function and an execution window of a corresponding function.

The controller may display, for example, a control menu to manipulate the function on the display in accordance with an extent of a change in the size of the image.

The controller, for example, may set the function in at least one of an icon mode, an intermediate mode, and a full mode in accordance with an extent of a change in the size of the image.

The controller, for example, may display the image as at least one of a thumbnail image and an icon if the icon mode is set.

The controller, for example, may perform the function automatically and displays part of the control menu executable related to the function if the intermediate mode is set.

The controller, for example, may perform the function automatically and displays all of the control menu executable related to the function if the full mode is set.

The controller, for example, may carry out at least one of moving and rotating the image according to the input from the user if at least one of the icon mode and the intermediate mode is set.

The controller may display an indicator informing change of a mode in accordance with an extent of a change in the size of the image.

The controller may switch the function to a changed mode and do not display the indicator when change of a mode is completed with the indicator being displayed.

The controller, for example, may change and display at least one of border, transparency, definition and color of an image if a mode is changed in accordance with an extent of a change in the size of the image.

According to another exemplary aspect of e the invention, there is provided a method of controlling an electronic apparatus preferably including: displaying an image corresponding to at least one executable function; receiving input from a user; changing a size of the image according to the input from the user; and carrying out at least one of automatic execution of the function and automatic closure of the function being performed in accordance with an extent of a change in the size of the image.

According to an exemplary aspect of the present invention, the method may further include carrying out at least one of enlarging and reducing the image according to the input received from the user.

The image may include, for example, at least one of an icon displaying a corresponding function and an execution window of a corresponding function.

The method may further include, for example, displaying a control menu to manipulate the function in accordance with an extent of a change in the size of the image.

The method may further include, for example, setting the function in at least one of an icon mode, an intermediate mode, and a full mode in accordance with an extent of a change in the size of the image.

The method may further include, for example, displaying the image as at least one of a thumbnail image and an icon if the icon mode is set.

The method may further include, for example, performing the function automatically and displaying part of the executable control menu related to the function if the intermediate mode is set.

The method may further include, for example, performing the function automatically and displaying all of the executable control menu related to the function if the full mode is set.

### BRIEF DESCRIPTION OF THE DRAWINGS

The above and/or other exemplary aspects will become apparent and more readily appreciated by a person of ordinary skill in the art from the following description of the exemplary embodiments, taken in conjunction with the accompanying drawings, in which:

FIG. 1 is a block diagram illustrating a configuration of an electronic apparatus according to one exemplary embodiment of the present invention;

FIG. 2 illustrates a function set up differently in different modes according to one exemplary embodiment of the present invention;

FIG. 3 illustrates functions set up differently in different modes according to another exemplary embodiment of the present invention;

FIGS. 4A and 4B illustrate an indicator displayed when a size of an image is enlarged according to one exemplary embodiment of the present invention;

FIGS. 5A and 5B illustrate an indicator displayed when a size of an image is reduced according to one exemplary embodiment of the present invention; and

FIG. 6 is a flow chart illustrating a process of controlling an electronic apparatus according to one exemplary embodiment of the present invention.

### DETAILED DESCRIPTION

Below, exemplary embodiments will be described in detail with reference to the accompanying drawings so as to be easily realized by a person having ordinary knowledge in the art. The exemplary embodiments may be embodied in various forms without the claimed invention being limited to the exemplary embodiments set forth herein. Descriptions of well-known structures and functions may be omitted for clarity, and like reference numerals refer to like elements throughout.

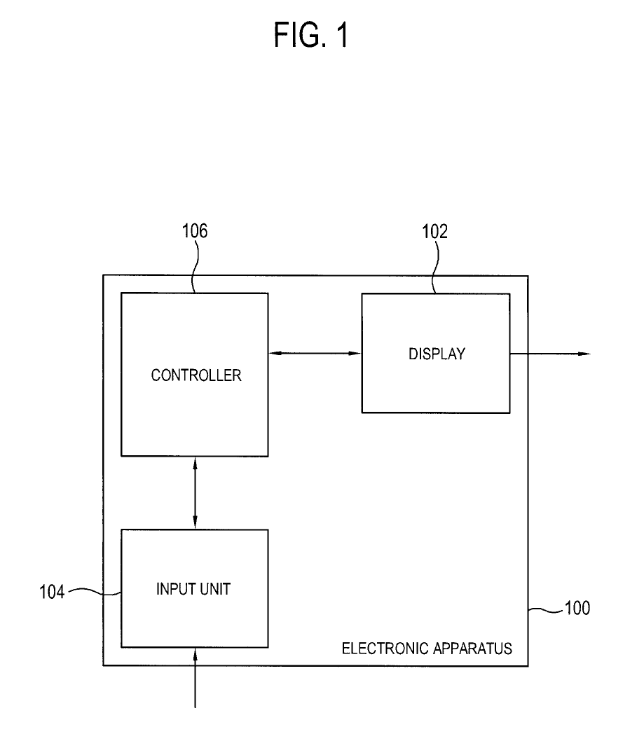

FIG. 1 is a block diagram illustrating a configuration of an electronic apparatus according to an exemplary embodiment of the present invention.

An electronic apparatus 100 according to an exemplary embodiment of the present invention may be a mobile terminal, a laptop computer, a desktop computer, a TV, a personal digital assistant (PDA), an MP3 (MPEG Audio Layer-3) player, etc. Further, the electronic apparatus 100 according to the exemplary embodiment of the present invention may include any device as long as it performs a plurality of functions and can display images related to the functions being performed.

The electronic apparatus 100 according to the exemplary embodiment of the present invention preferably includes a display 102, a user input unit 104, and a controller 106.

The display 102 displays an image corresponding to at least one executable function. In this case, the image may include, for example, at least one of an icon displaying a corresponding function and an execution window of the corresponding function. The function may include every program or application which the electronic apparatus 100 can perform, e.g., music, photos, videos, documents, internet, broadcasting, menus, etc.

According to an exemplary embodiment of the present invention, the display 102 may be realized as a touch screen, a touch panel, or the like.

Meanwhile, the display 102 may include a display panel realized as a liquid crystal display (LCD), an organic light emitting display (OLED), a plasma display panel (PDP) or the like, and a panel driver. Any thin-film technology display screen can be used, and the display may comprise a touch screen as well, and the touch screen may have multi-touch capability.

The input unit 104 receives a user's input. Specifically, user's input includes selection, execution, change and close of a function, enlargement or reduction of an image corresponding to a function, etc. According to an exemplary embodiment of the present invention, a user may enlarge or reduce an image through a multi-touch input.

The input unit 104 may receive the user's input through the display 102 realized as a touch screen or a touch panel. Furthermore, the input unit 104 may receive a user's input through a key button provided in the electronic apparatus 100, a pointing device such as a mouse connected via a cable or wirelessly to the electronic apparatus 100, a remote control, etc.

The controller 106 changes an image size according to a user's input and performs at least one of automatic execution of a function and automatic closure of a function being executed in accordance with the extent of a change in the size of an image. In this case, the controller 106 may carry out at least one of enlarging and reducing the image according to user's input.

According to an exemplary embodiment of the present invention, the controller 106 may display a control menu for manipulating a function corresponding to the extent of a change in the size of an image on the display 102. The control menu may include a plurality of menus related to manipulating the function. For example, a control menu to adjust a music function may include play, pause, stop, next file, previous file, volume up, volume down, etc.

Alternatively, the controller 106 may set up a function in one of an icon mode, an intermediate mode, and a full mode corresponding to the extent of a change in the size of an image. If a function is set up in the icon mode, the controller 106, for example, may display an image corresponding to the function as at least one of a thumbnail image or an icon. If a function is set up in the intermediate mode, the controller 106 performs the function automatically and displays part of the control menu which is executable related to the function. If a function is set up in the full mode, the controller 106 performs the function automatically and displays all the control menu which is executable related to the function. Meanwhile, when set up in at least one of the icon mode and the intermediate mode, the controller 106 may carry out at least one of moving and rotating an image according to user's input.

According to another exemplary embodiment of the present invention, the controller 106 may display an indicator that displays a change of mode corresponding to the extent of a change in the size of an image. In this case, when there is change of a mode that has been completed and the indicator is being displayed, the controller 106 may then switch a function to a changed mode and not display the indicator.

According to still another exemplary embodiment of the present invention, when a mode is changed corresponding to the extent of a change in the size of an image, the controller 106 may change and display at least one of border, transparency, definition and color of an image.

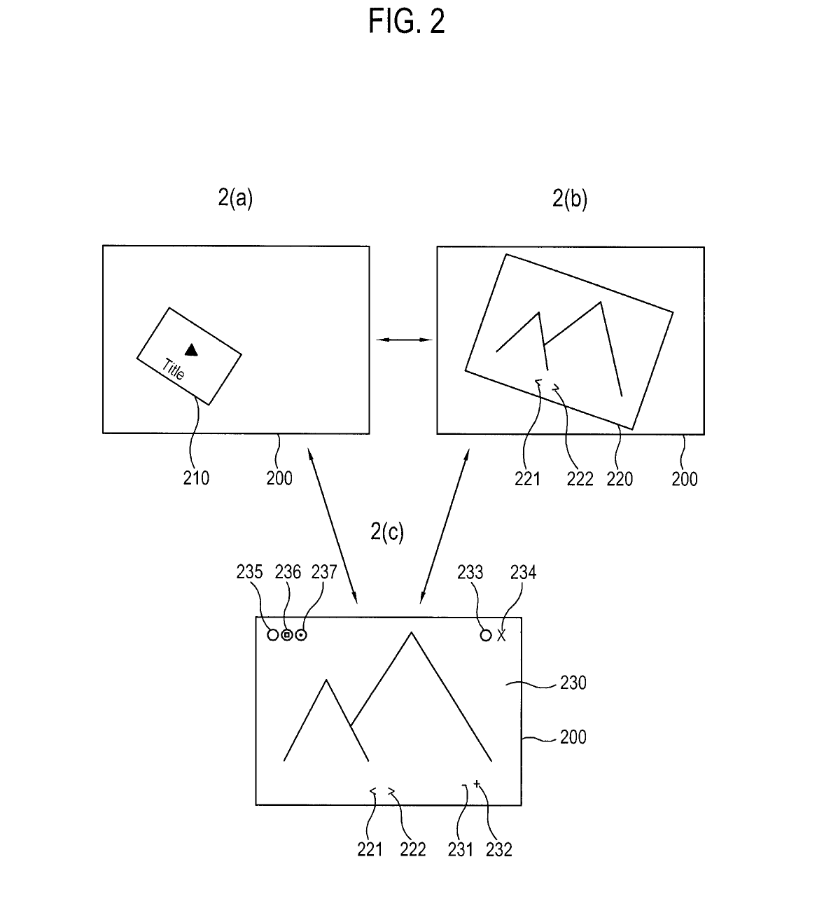

FIG. 2 illustrates a function set up differently in different modes according to another exemplary embodiment of the present invention.

FIG. 2 is a hypothetical case where a user selected file is executed via a video function.

The mode shown in (a) illustrates a case where a video function is set in the icon mode. In the icon mode, the user selected file is displayed as an icon 210 in an area of a full screen 200. If the video function is changed into the icon mode with the selected file being replayed, the replay of the file is finished.

The mode shown in (b) illustrates a case where a video function is set in the intermediate mode. In the intermediate mode, the selected file is automatically replayed. In this case, the user selected file is displayed in an execution window 220 which is smaller than the full screen 200 and larger than the icon 210 displayed in (a). Further, in the intermediate mode, parts 221 and 222 of an executable control menu related to the video function are displayed.

The mode shown in (c) illustrates a case where a video function is set in the full mode. In the full mode, the selected file is automatically replayed. In this case, the user selected file is displayed in an execution window 230 which is the same in size as the full screen 200. Further, in the full mode, all executable control menu 221, 222, 231, 232, 233, 234, 235, 236, and 237 related to the video function are displayed.

Meanwhile, a user may set or change the video function in the icon mode (a), the intermediate mode (b), and the full mode (c) by changing a size of the icon 210 or the execution windows 220 and 230. Specifically, if the user enlarges the icon 210 to a size of the execution window 220 in the intermediate mode (b), the function is then switched to the intermediate mode (b). In this state, if the user enlarges the execution window 220 in the intermediate mode (b) to a size of the execution window 230 in the full mode (c), the function is then switched to the full mode (c). Likewise, if the user enlarges the icon 210 to the size of the execution window 230 in the full mode (c), the function is directly switched to the full mode (c).

Conversely, if the user reduces the execution window 230 in the full mode (c) to the size of the execution window 220 in the intermediate mode (b), the function is then switched to the intermediate mode (b). In this state, if the user reduces the execution window 220 in the intermediate mode (b) to a size of the icon 210, the function is switched to the icon mode (a). Likewise, if the user reduces the execution window 230 in the full mode (c) to the size of the icon 210, the function is directly switched to the icon mode (a).

In this manner, the user may perform a function automatically or finish a function being executed automatically by changing a size of an image corresponding to the function. Thus, there is provided a user interface which is convenient and immediate for the user.

Moreover, a control menu for controlling a function may be displayed differently according to a size of an image corresponding to the function. Specifically, the number of menus may correspond differently according to the size of an image. For example, if the video function is set in the full mode, all the menus related to execution of the video function, e.g., stop, pause, volume control, image quality control, edit, menu, etc, are displayed. If the video function is set in the intermediate mode, only a minimum menu to replay a video, e.g., stop, pause, etc., may be displayed. Thus, a control menu that is only required for a user according to a setup mode may be provided.

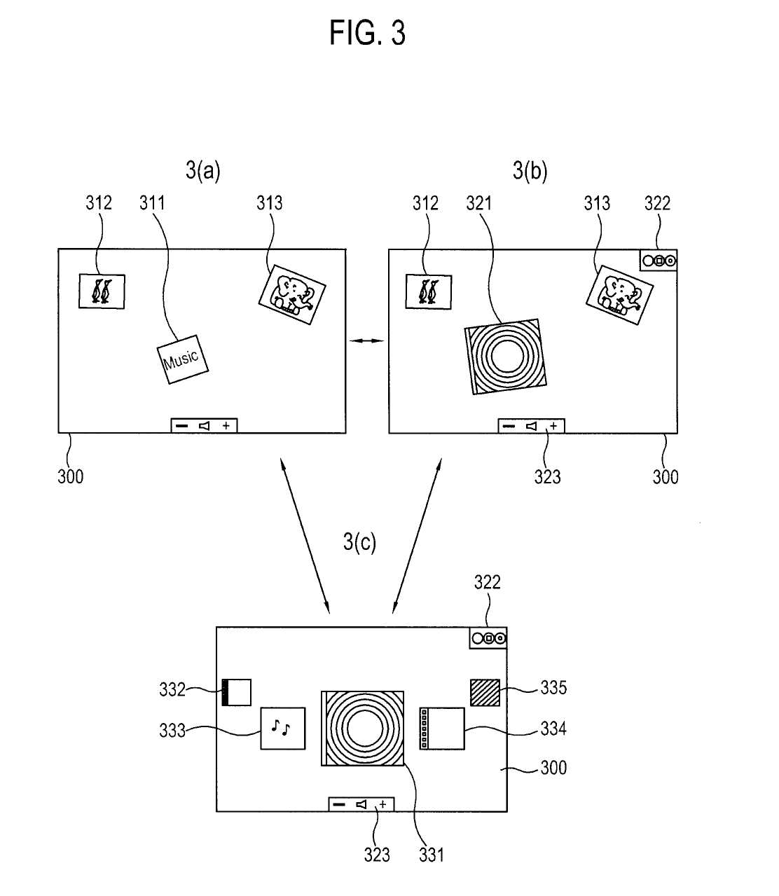

FIG. 3 illustrates functions set up differently in different modes according to another exemplary embodiment of the present invention.

FIG. 3 assumes a case wherein a music function is executed among a plurality of functions displayed on a screen.

Referring to FIG. 3, in item (a), a plurality of icons 311, 312 and 313 are displayed on a screen 300. In other words, functions corresponding to the icons 311, 312 and 313, respectively, in (a) are set in the icon mode. Thus, only the icons 311, 312 and 313 corresponding to the functions are displayed, but the functions are not automatically performed.

Still referring to FIG. 3, item (b) shows that in the (a) state, a user enlarges the icon 311 corresponding to the music function to a size of an execution window 321 in the intermediate mode. In this case, the music function is switched to the intermediate mode. Thus, music begins being played automatically, and parts 322 and 323 of an executable control menu along with the music function are displayed. Meanwhile, as other icons 312 and 313 remain unchanged in size as being displayed in (a), they are kept in the icon mode.

With further regard to FIG. 3, item(c) shows a case where a user slightly enlarges the execution window 321 in the intermediate mode. Since the execution window 331 does not reach a size of an execution window in the full mode, the music function can not be switched to the full mode but continues in the intermediate mode. Thus, music is kept so as to be automatically replayed. Furthermore, the parts 322 and 323 of the executable control menu along with the music function are still displayed as exhibited in (b).

Meanwhile, with continued reference to FIG. 3, the user is allowed to move and rotate the execution window 321 in the (b) state. In this case, position and direction of an execution window 331 may be changed as shown in (c). Moreover, the user may finish using the displayed icons 312 and 313 in the (b) state. In this case, the icons 312 and 313 disappear from the screen 300 as shown in (c). In addition, the user may sequentially display files to be replayed on the screen in the (b) state. In this case, images 332, 333, 334 and 335 corresponding to a plurality of files may be displayed on the screen 300 as shown in (c).

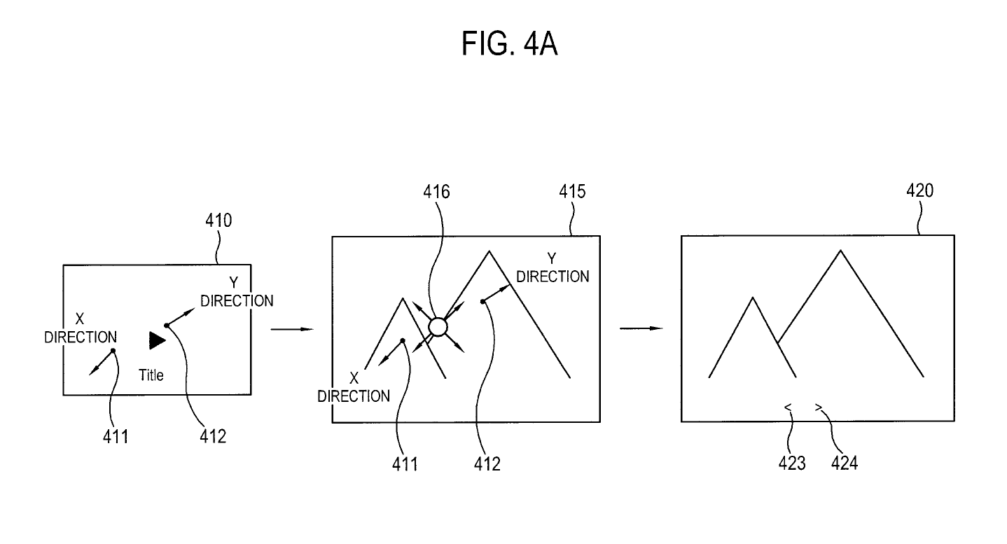

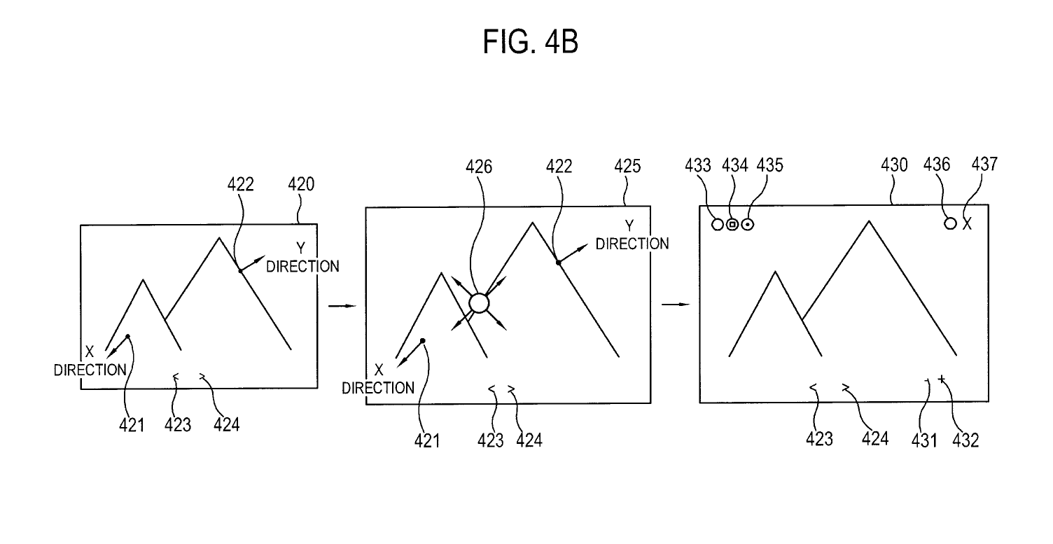

FIGS. 4A and 4B illustrate an indicator displayed when a size of an image is enlarged according to one exemplary embodiment of the present invention.

The indicator may report change of a mode in accordance with the extent of a change in the size of an image.

FIG. 4A shows an example of execution mode of a function being changed from the icon mode to the intermediate mode. If the function is set in the icon mode, an icon 410 corresponding to the function is displayed. In this case, a user touches the icon 410 to enlarge the icon 410 in an X-direction 411 or a Y-direction 412. Instead, multi-touch may be used to enlarge the icon 410 in the X-direction 411 and the Y-direction 412 simultaneously.

When the icon 410 is enlarged to reach a size of an execution window 415 in the intermediate mode, an indicator 416 informing change of the mode is displayed. The function may be performed in the intermediate mode after mode change is completed. Thus, in this case, the function is not yet automatically executed. Furthermore, an executable control menu related to the function is not displayed at this stage either. When the mode change is completed with the indicator 416 being displayed, the execution mode of the function is changed to the intermediate mode at the same time as the indicator 416 disappears. Specifically, when the user removes a finger from the display, the mode change may be completed.

When the function is switched to the intermediate mode, the function starts performing automatically. In addition, parts 423 and 424 of an executable control menu related to the function are displayed on an execution window 420.

FIG. 4B shows an example of the execution mode of the function being changed from the intermediate mode to the full mode.

If the function is set in the intermediate mode, the function is automatically performed. That is, the execution window 420 of the function is displayed on a screen, and the parts 423 and 424 of the executable control menu related to the function are displayed on the execution window 420. In this case, the user may touch the execution window 420 to enlarge the execution window 420 in at least one of the X direction 421 and/or the Y direction 422.

When the execution window 420 is enlarged to reach a size of an execution window 425 in the full mode, an indicator 426 informing change of the mode is displayed. The function may be changed to the full mode after the mode change is completed. Thus, in this case, not all of items 423, 424, 431, 432, 433, 434, 435, 436 and 437 of the executable control menu related to the function, but rather only the items 423 and 424 are displayed. When the mode change is completed with the indicator 426 being displayed, the execution mode of the function is changed to the full mode at the same time as the indicator 426 disappears.

When the function is changed to the full mode, the functions keeps being executed. Further, all 423, 424, 431, 432, 433, 434, 435, 436 and 437 of the executable control menu related to the function are displayed on an execution window 430.

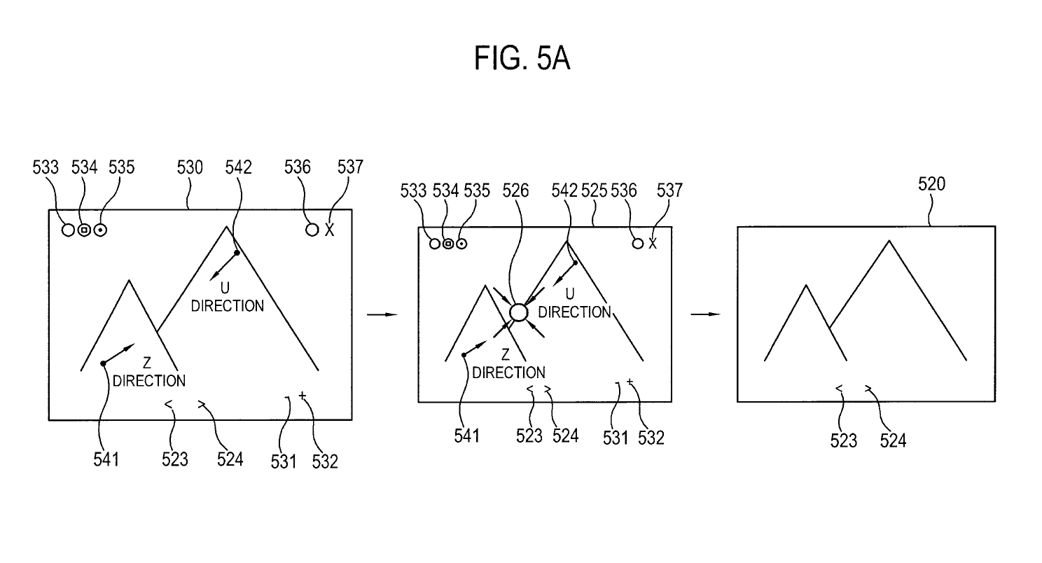

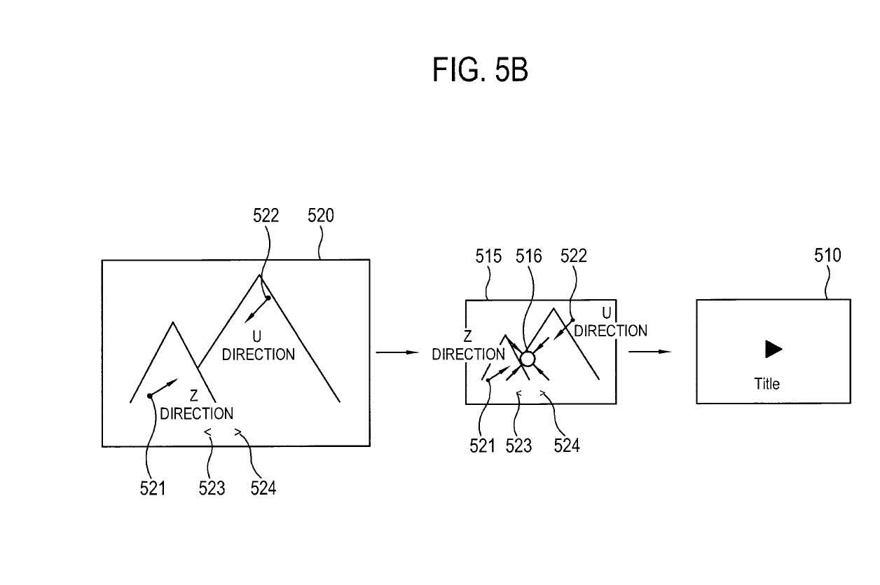

FIGS. 5A and 5B illustrate an indicator displayed when a size of an image is reduced according to one exemplary embodiment of the present invention.

FIG. 5A shows an execution mode of a function being changed from the full mode to the intermediate mode. When the function is set in the full mode, the function is automatically performed. Specifically, an execution window 530 of the function is displayed in a size of full screen, and all of items 523, 524, 531, 532, 533, 534, 535, 536 and 537 of an executable control menu related to the function are displayed on the execution window 530. In this case, a user may touch the execution window 530 to reduce the execution window 530 in at least one of a Z-direction 541 and/or a U-direction 542.

When the execution window 530 is reduced to reach a size of an execution window 525 in the intermediate mode, an indicator 526 informing change of the mode is displayed. The function may be changed to the intermediate mode after mode change is completed. Thus, all of items 523, 524, 531, 532, 533, 534, 535, 536 and 537 of the executable control menu related to the function are kept displayed on the execution window 530. When the mode change is completed with the indicator 526 being displayed, the execution mode of the function is changed to the intermediate mode at the same time as the indicator 526 disappears. Specifically, when the user removes a finger from the display, the mode change may be completed.

When the function is switched to the intermediate mode, the function keeps being performed automatically. In this case, a size of an execution window 520 gets smaller than the size of the full screen. In addition, parts 523 and 524 of the executable control menu related to the function are displayed on the execution window 520.

FIG. 5B shows the execution mode of the function being changed from the intermediate mode to the icon mode.

If the function is set in the intermediate mode, the function is automatically performed. That is, the execution window 520 of the function is displayed on a screen, and the parts 523 and 524 of the executable control menu related to the function are displayed on the execution window 520. In this case, the user may touch the execution window 520 to reduce the execution window 520 in at least one of the Z-direction 521 and/or the U direction 522.

When the execution window 520 is reduced to reach a size of an icon 515 in the icon mode, an indicator 516 informing change of the mode is displayed. The function may be changed to the icon mode after mode change is completed. Thus, in this case, the function keeps being executed. Further, the parts 523 and 524 of the executable control menu related to the function are kept displayed. When the mode change is completed with the indicator 516 being displayed, the execution mode of the function is changed to the icon mode at the same time as the indicator 516 disappears.

When the function is switched to the icon mode, the function being performed is automatically finished. Then, the function is displayed in a corresponding icon 510.

In the case of a mobile device having a small screen, as there are more control menus displayed, each menu is displayed in a smaller size. In this case, there is difficulty of touch input with a finger. That is, a user may make a mistake of touching a neighboring control menu so that a desired function is not performed.

According to the present invention, such a problem may be resolved by varying control menus displayed according to a size of a program.

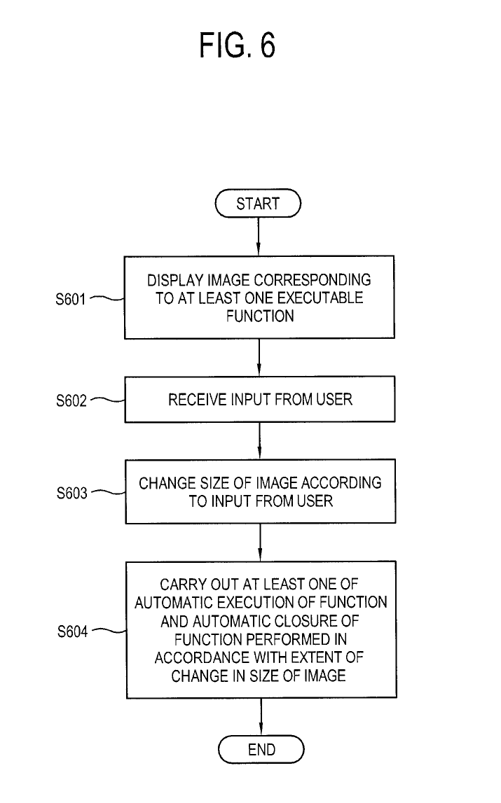

FIG. 6 is a flow chart illustrating a process of controlling an electronic apparatus according to one exemplary embodiment of the present invention.

At (S601), the electronic apparatus 100 displays an image corresponding to at least one executable function. The image may include at least one of an icon displaying a corresponding function and an execution window of a corresponding function.

At (602), the electronic apparatus 100 receives user's input.

At (S603), the electronic apparatus 100 changes a size of an image according to the user's input. Specifically, the electronic apparatus 100 may perform at least one of an enlarging and a reducing of the image according to the user's input.

At (S604), the electronic apparatus 100 conducts at least one of automatic execution of the function and automatic closure of the function being performed in accordance with an extent of a change in the size of the image. Further, the electronic apparatus 100 may display a control menu to manipulate a function in accordance with the extent of a change in the size of the image.

As described above, the present invention provides an interface which is convenient and immediate for a user in controlling or performing a plurality of executable functions in an electronic apparatus.

The above-described methods according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An electronic apparatus comprising:
a display displaying an image corresponding to at least one executable function;
an input unit receiving input from a user associated with said at least one executable function; and
a controller for changing a size of the displayed image according to the received input and for performing at least one of: (1) an automatic execution of said at least one executable function, and (2) an automatic closure of said at least one executable function being performed in accordance with an extent of a change in the size of the image based on the input received by the input unit.

2. The electronic apparatus according to claim 1, wherein the controller controls at least one of enlarging and reducing the displayed image according to the input from the user associated with said at least one executable function.

3. The electronic apparatus according to claim 1, wherein the displayed image comprises at least one of an icon displaying a corresponding function and an execution window of a corresponding function of said at least one executable function.

4. The electronic apparatus according to claim 1, wherein the controller displays a control menu for manipulating said at least one executable function on the display in accordance with an extent of a change in the size of the displayed image.

5. The electronic apparatus according to claim 1, wherein the controller sets said at least one executable function in at least one of an icon mode, an intermediate mode, and a full mode in accordance with an extent of a change in the size of the displayed image.

6. The electronic apparatus according to claim 5, wherein when the icon mode is set the controller controls display of the image as at least one of a thumbnail image and an icon.

7. The electronic apparatus according to claim 5, wherein when the intermediate mode is set the controller performs the function automatically and controls display of part of an executable control menu related to the function said at least one executable function.

8. The electronic apparatus according to claim 5 wherein when the full mode is set the controller performs the at least one executable function automatically and displays all of an executable control menu related to the function.

9. The electronic apparatus according to claim 5, wherein when at least one of the icon mode and the intermediate mode is set the controller controls at least one of moving and rotating the displayed image according to the received input from the input unit.

10. The electronic apparatus according to claim 5, wherein the controller controls display of an indicator informing of a change of a mode in accordance with an extent of a change in the size of the image.

11. The electronic apparatus according to claim 10, wherein the controller switches said at least one executable function to a changed mode and controls the display so that the display does not show a change in indication when a change of a mode is completed while the indicator is being displayed.

12. The electronic apparatus according to claim 5, wherein the controller changes and displays at least one of border, transparency, definition and color of the displayed image when a mode is changed in accordance with an extent of a change in the size of the displayed image.

13. A method of controlling an electronic apparatus comprising:
displaying an image corresponding to at least one executable function;
receiving input from a user regarding said at least one executable function;
changing a size of the displayed image according to the input received from the user; and
performing at least one of an automatic execution of said at least one executable function and automatic closure of said at least one executable function being performed in accordance with an extent of a change in the size of the displayed image.

14. The method according to claim 13, further comprising performing at least one of enlarging and reducing the image according to the input received from the user.

15. The method according to claim 13, wherein the displayed image comprises at least one of an icon displaying a corresponding function and an execution window of a corresponding function of said at least one executable function.

16. The method according to claim 13, further comprising displaying a control menu to manipulate said at least one executable function in accordance with an extent of a change in the size of the displayed image.

17. The method according to claim 13, further comprising setting said at least one executable function in at least one of an icon mode, an intermediate mode, and a full mode in accordance with an extent of a change in the size of the displayed image.

18. The method according to claim 17, further comprising when the icon mode is set displaying the image as at least one of a thumbnail image and an icon.

19. The method according to claim 17, further comprising when the intermediate mode is set performing the function automatically and displaying part of an executable control menu related to the function.

20. The method according to claim 17, further comprising when the full mode is set performing the function automatically and displaying all of an executable control menu related to the function.
